(19) United States
(12) Patent Application Publication
(10) Pub. No.: US 2025/0353479 A1
(43) Pub. Date: Nov. 20, 2025

(54) BRAKE SYSTEM AND METHOD OF CONTROLLING THE SAME

(71) Applicant: HL MANDO CORPORATION, Gyeonggi-do (KR)

(72) Inventor: Kwanseek KIM, Gyeonggi-do (KR)

(21) Appl. No.: 19/094,551

(22) Filed: Mar. 28, 2025

(30) Foreign Application Priority Data
May 14, 2024 (KR) 10-2024-0063312
Nov. 7, 2024 (KR) 10-2024-0157191

(51) Int. Cl. B60T 8/96; B60T 8/171; B60T 8/172; B60T 8/58; B60T 8/88; B60T 13/14; B60T 13/58; B60T 13/74; B62D 5/04

(52) U.S. Cl. CPC B60T 8/96; B60T 8/171; B60T 8/172; B60T 8/58; B60T 8/885; B60T 13/142; B60T 13/148; B60T 13/588; B60T 13/745; B62D 5/046; B60T 2220/04; B60T 2240/00; B60T 2270/402; B60T 2270/404; B60T 2270/406; B60T 2270/416; B60T 2270/82

(57) ABSTRACT

A brake system may include a plurality of wheel speed sensors respectively installed in a plurality of wheels of a vehicle, a plurality of hydraulic brake modules related to braking of the plurality of wheels, and a first controller configured to perform braking control on the plurality of hydraulic brake modules in response to at least one of a pedal displacement signal, which corresponds to a movement of a brake pedal, and wheel speed signals outputted from the wheel speed sensors, in which when a failure of the first controller is identified, a second controller, which is provided in a steering system of the vehicle, performs braking control on an electronic parking brake, which is provided in at least one of the plurality of wheels, in response to at least one of an operating signal of an EPB switch, the pedal displacement signal, and the wheel speed signals outputted from the wheel speed sensors.

### CROSS-REFERENCE TO RELATED APPLICATIONS

This application claims the priority of Korean Patent Application No. 10-2024-0063312 filed on May 14, 2024, in the Korean Intellectual Property Office, and Korean Patent Application No. 10-2024-0157191 filed on Nov. 7, 2024, in the Korean Intellectual Property Office, the disclosure of which is incorporated herein by reference.

### BACKGROUND

### Field

The disclosed disclosure relates to a brake system and a method of controlling the same.

### Description of the Related Art

With the advancement of vehicle technologies and the increasing demand for safety of drivers and occupants, there is a need for more efficient, safer braking systems. A hydraulic brake system in the related art provides a predetermined level of braking performance by generating a braking force by converting an operating force of a brake pedal into hydraulic pressure. However, the hydraulic brake system has a limitation in terms of a reaction speed and accuracy and has a problem in that efficiency is degraded by complexity and weight of a hydraulic system.

An integrated dynamic brake (IDB) system developed to solve the above-mentioned problem electrohydraulically controls a braking force by converting the operating force of the brake pedal into an electrical signal. The IDB refers to an integrated electromechanical brake made by combining an electronic booster and electronic stability control (ESC). The IDB may more quickly and accurately brake the vehicle and easily distribute the braking force, thereby providing further improved stability and braking performance in comparison with the hydraulic system in the related art. In addition, the IDB may substitute for the hydraulic system, simplify the system, and reduce the weight, thereby providing a significant advantage even in terms of efficiency.

Recently, an electronic control brake system, such as the IDB, includes an electronic parking brake (EPB). For this reason, when an electronic control unit (ECU) fails, most brake functions including a service brake function and a parking brake function are lost.

### SUMMARY

An object to be achieved by the present disclosure is to provide a brake system and a method of controlling the same, in which an EPB module included in an electronic control brake controller is moved to and disposed in an electronic power steering (EPS) system to cope with a failure of an electronic control brake controller.

Another object to be achieved by the present disclosure is to provide a brake system and a method of controlling the same, in which an EPB module is used to perform an independent brake function when an electronic control brake controller fails.

A brake system according to an exemplary embodiment of the present disclosure may include: a plurality of wheel speed sensors respectively installed in a plurality of wheels of a vehicle; a plurality of hydraulic brake modules related to braking of the plurality of wheels; and a first controller configured to perform braking control on the plurality of hydraulic brake modules in response to at least one of a pedal displacement signal, which corresponds to a movement of a brake pedal, and wheel speed signals outputted from the wheel speed sensors, in which when a failure of the first controller is identified, a second controller, which is provided in a steering system of the vehicle, performs braking control on an electronic parking brake, which is provided in at least one of the plurality of wheels, in response to at least one of an operating signal of an EPB switch, the pedal displacement signal, and the wheel speed signals outputted from the wheel speed sensors.

The brake system may further include: a liquid pressure supply module configured to supply liquid pressure to the plurality of hydraulic brake modules by being operated by a first motor, in which the first controller includes: a first processor configured to perform braking control on at least one of the plurality of hydraulic brake modules; and a first driver circuit configured to control the first motor to allow the liquid pressure supply module to supply the liquid pressure to at least one of the plurality of hydraulic brake modules in response to a control signal outputted from the first processor.

The electronic parking brake may perform at least one of a service brake function, which provides a braking force in a traveling situation of the vehicle, and a parking brake function that maintains a stopped state of the vehicle.

The second controller of the steering system may include: a second processor configured to control at least one of the steering system and the electronic parking brake; a second driver circuit configured to control a second motor, which provides driving power in the steering system, in response to a control signal outputted from the second processor; and a third driver circuit configured to control a third motor, which provides driving power in the electronic parking brake, in response to the control signal outputted from the second processor.

The plurality of wheel speed sensors may each output the wheel speed signal through a first channel and a second channel, output the wheel speed signal to the first controller through the first channel, and output the wheel speed signal to the second controller of the steering system through the second channel.

The second controller of the steering system may perform braking control on the electronic parking brake by receiving the wheel speed signal from the first controller on the basis of a result of identifying a failure of the second channel.

When a failure of the wheel speed sensor installed in at least one of the plurality of wheels is identified, the first controller may perform braking control on the hydraulic brake module in response to the wheel speed signal outputted from the wheel speed sensor installed in the remaining wheel.

The brake system may further include: an internal communication network configured to connect the first controller and the second controller of the steering system, in which the first controller and the second controller of the steering system identify states thereof through the internal communication network.

The plurality of wheel speed sensors may include first and second wheel speed sensors respectively installed in first and second wheels of the vehicle.

The second controller of the steering system may perform braking control on the electronic parking brake installed in a second wheel of the vehicle.

The second controller of the steering system may perform braking control on the electronic parking brakes respectively installed in first and second wheels of the vehicle.

The brake system may further include: first and second hydraulic pressure supply modules configured to supply hydraulic pressure to the hydraulic brake module, in which the first controller controls the first and second hydraulic pressure supply modules to supply the hydraulic pressure to the hydraulic brake module.

Another exemplary embodiment of the present disclosure provides a method of controlling a brake system, which includes a plurality of wheel speed sensors respectively installed in a plurality of wheels of a vehicle, a plurality of hydraulic brake modules related to braking of the plurality of wheels, and a first controller configured to perform braking control on the plurality of hydraulic brake modules, the method including: performing, by the first controller, braking control on the plurality of hydraulic brake modules in response to at least one of a pedal displacement signal, which corresponds to a movement of a brake pedal, and wheel speed signals outputted from the wheel speed sensors; and performing, by a second controller provided in a steering system of the vehicle, braking control on an electronic parking brake, which is provided in at least one of the plurality of wheels, in response to at least one of an operating signal of an EPB switch, the pedal displacement signal, and the wheel speed signals outputted from the wheel speed sensor when a failure of the first controller is identified.

The method may further include: controlling, by the first controller, a first motor of a liquid pressure supply module configured to supply liquid pressure to the plurality of hydraulic brake modules.

The method may further include: controlling a second motor, which provides driving power in the steering system, by the second controller of the steering system; and controlling a third motor configured to provide driving power to the electronic parking brake.

The method may further include: outputting, by the plurality of wheel speed sensors, the wheel speed signals through first and second channels, in which the wheel speed signal is outputted to the first controller through the first channel, and the wheel speed signal is outputted to the second controller of the steering system through the second channel.

The method may further include: performing, by the second controller of the steering system, braking control on the electronic parking brake by receiving the wheel speed signal from the first controller on the basis of a result of identifying a failure of the second channel.

The method may further include: performing, by the first controller, braking control on the hydraulic brake module in response to the wheel speed signal outputted from the wheel speed sensor installed in the remaining wheel when a failure of the wheel speed sensor installed in at least one of the plurality of wheels is identified.

The method may further include: performing, by the second controller of the steering system, braking control on the electronic parking brake installed in a second wheel of the vehicle; and performing braking control on the electronic parking brakes respectively installed in a first wheel and the second wheel of the vehicle.

One aspect of the disclosed disclosure may provide the brake system and the method of controlling the same, in which the EPB module included in the electronic control brake controller is moved to and disposed in the electronic power steering (EPS) system to cope with a failure of the electronic control brake controller.

One aspect of the disclosed disclosure may provide the brake system and the method of controlling the same, in which the EPB module is used to perform the independent brake function when the electronic control brake controller fails.

Therefore, the brake system and the method of controlling the same may ensure the redundancy capable of coping with the failure of the electronic control brake controller and prevent an increase in costs and an addition of processes due to the addition of other devices.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a configuration of a brake system according to a first embodiment of the disclosed disclosure;

FIG. 2 is a view illustrating a configuration of a steering system of a vehicle according to the embodiment of the disclosed disclosure;

FIG. 3 is a view illustrating a connection relationship between components included in the brake system according to the embodiment of the disclosed disclosure;

FIG. 4 is a view illustrating a structure of a liquid pressure supply module included in the brake system according to the embodiment of the disclosed disclosure;

FIG. 5 is a view illustrating an example of an electronic parking brake according to the embodiment of the disclosed disclosure;

FIG. 6 is a view illustrating a configuration of a brake system according to a second embodiment of the disclosed disclosure;

FIG. 7 is a view illustrating a connection relationship between components included in the brake system according to the second embodiment of the disclosed disclosure;

FIG. 8 is a view illustrating a connection relationship between components included in a brake system according to a third embodiment of the disclosed disclosure;

FIG. 9 is a view illustrating a connection relationship between components included in a brake system according to a fourth embodiment of the disclosed disclosure;

FIG. 10 is a view illustrating a connection relationship between components included in a brake system according to a fifth embodiment of the disclosed disclosure;

FIG. 11 is a view illustrating a connection relationship between components included in a brake system according to a sixth embodiment of the disclosed disclosure; and

FIG. 12 is a view illustrating a method of controlling the brake system according to the embodiment of the disclosed disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

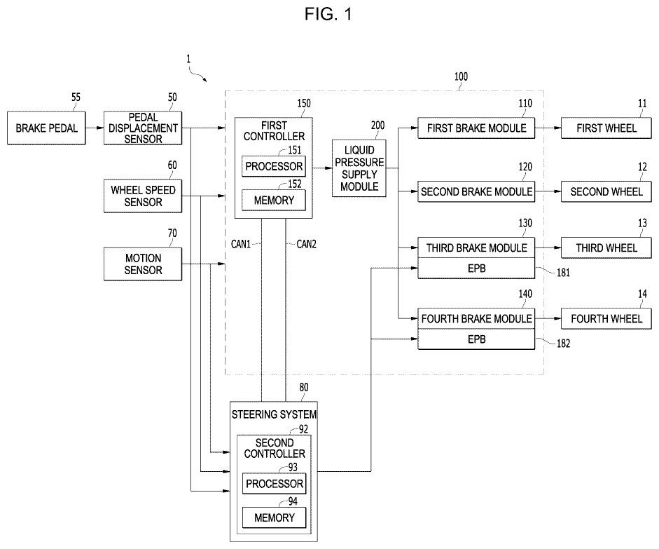

FIG. 1 is a view illustrating a brake system according to an embodiment of the disclosed disclosure and a configuration of a vehicle related to the brake system.

With reference to FIG. 1, a vehicle 1 may include a plurality of wheels 11, 12, 13, and 14 configured to rotate to move the vehicle 1, a brake pedal 55 configured to acquire an input related to braking from a driver, a pedal displacement sensor 50 configured to detect a movement of the brake pedal 55, a wheel speed sensor 60 configured to detect rotational speeds of the plurality of wheels 11, 12, 13, and 14, a motion sensor 70 configured to detect a motion of the vehicle 1, a steering system 80 configured to operate to change a traveling direction of a vehicle while corresponding to the driver's manipulation, and a brake system 100 configured to provide the plurality of wheels 11, 12, 13, and 14 with a braking force for stopping the vehicle 1. The pedal displacement sensor 50, the wheel speed sensor 60, and/or the motion sensor 70 are not essential components, and all or at least some of the above-mentioned components may be excluded.

For example, the plurality of wheels 11, 12, 13, and 14 may include a first wheel 11 provided at a front left side of the vehicle 1, a second wheel 12 provided at a front right side of the vehicle 1, a third wheel 13 provided at a rear left side of the vehicle 1, and/or a fourth wheel 14 provided at a rear right side of the vehicle 1. However, the number of wheels 11, 12, 13, and 14 is not limited to four.

For example, the brake pedal 55 may be provided at a lower side of a cabin so that the driver may control the brake pedal 55 with his/her foot. The driver may push the brake pedal 55 in accordance with a braking intention to brake the vehicle 1. In accordance with the driver's braking intention, the brake pedal 55 may depart from a reference position and move.

The pedal displacement sensor 50 may be installed in the vicinity of the brake pedal 55 and measure the movement of the brake pedal 55 made by the driver's braking intention. For example, the pedal displacement sensor 50 may detect a movement distance and/or a movement speed of the brake pedal 55 from a reference position.

The pedal displacement sensor 50 may be electrically connected to the brake system 100 and provide an electrical signal to the brake system 100. For example, the pedal displacement sensor 50 may be connected directly to the brake system 100 through a hard wire or connected to the brake system 100 through a communication network. In addition, the pedal displacement sensor 50 may provide the brake system 100 with an electrical signal corresponding to the movement distance and/or the movement speed of the brake pedal 55. In addition, the pedal displacement sensor 50 may be integrated with the brake system 100.

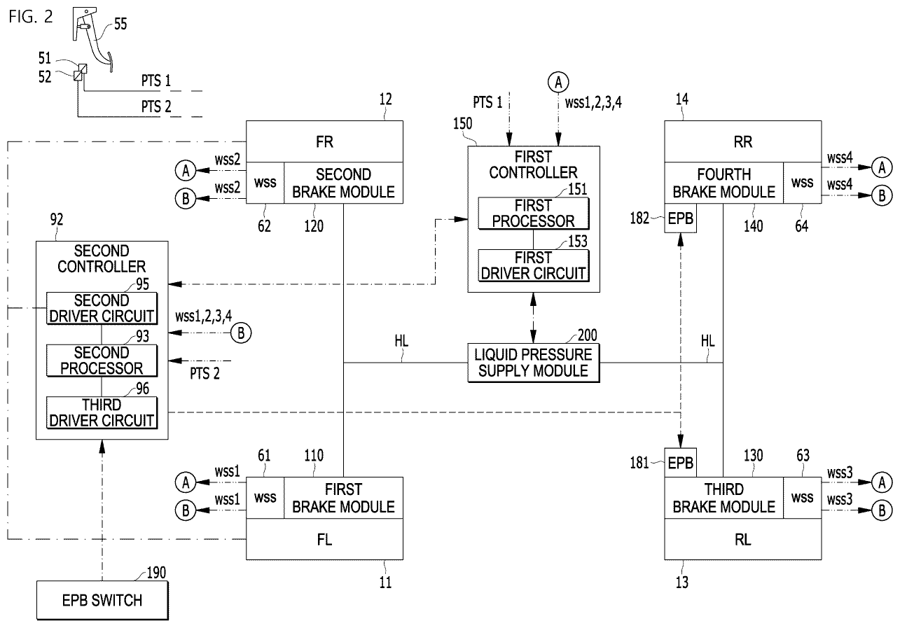

With reference to FIG. 2, the steering system 80 may include a steering wheel 81 configured to be rotated by the user's manipulation, a steering column 82 connected to the steering wheel 81 and configured to rotate in conjunction with the steering wheel 81, a pinion gear 83 connected to the steering column 82, a rack bar 84 provided between the two wheels 11 and 12 and connected to the pinion gear 83, a ball nut 85 movably coupled to the rack bar 84, a pulley 87 connected to the ball nut 85 through a belt 86, a steering motor 88 connected to the pulley 87, and a second controller 92 configured to control an operation of the steering motor 88.

The steering system 80 may further include a torsion bar 142a provided between the steering column 82 and the pinion gear 83.

The steering system 80 may further include a rack gear 84a provided on the rack bar 84 and connected to the pinion gear 83.

The steering system 80 may further include tie rods 89a and knuckle arms 89b respectively provided at two opposite ends of the rack bar 84 and configured to connect the rack bar 84 and the wheels 11 and 12.

The pinion gear 83 may be coupled to and engage with the rack gear 84a formed on the rack bar 84. The pinion gear 83 and the rack gear 84a, which engage with each other as described above, may operate in conjunction with each other by means of a predetermined gear ratio.

The steering motor 88 serves to supply auxiliary power for steering the vehicle and rotates on the basis of steering information of the steering wheel 81.

An operation of the steering system 80 will be described briefly. When the steering wheel 81 is manipulated by the user, the steering column 82 may transmit steering torque, which is generated by the steering wheel 81, to the pinion gear 83. Further, the pinion gear 83 may convert the steering torque of the steering wheel 81 into a rectilinear moving force while operating in conjunction with the rack gear 84a. That is, when the user manipulates the steering wheel 81, steering torque is generated, and the rack gear 84a and the pinion gear 83 are operated in conjunction with each other by the generated steering torque, thereby steering the front wheels 11 and 12 by means of the tie rod 89a and the knuckle arm 89b. In this case, the rack gear 84a and the pinion gear 83 may operate in conjunction with each other on the basis of the predetermined gear ratio.

At the same time, the steering system 80 may operate the steering motor 88 on the basis of steering information created by the manipulation of the steering wheel 81. The steering motor 88 may transmit motor torque, which is generated by the operation, to the belt 86 through the pulley 87. The pulley 87 may be rotated by the motor torque. In this case, a rotational force of the pulley 87 may be transmitted to the belt 86, and the rotational force of the belt 86 may be transmitted to the ball nut 85. The ball nut 85 may slide the rack bar 84 while rotating. That is, the rack bar 84 is rotated relative to the ball nut 85 by the rotation of the ball nut 85 and moves in a longitudinal direction (an axial direction of the rack bar).

As described above, the steering system 80 is configured such that auxiliary power, which is generated by the steering motor 88 on the basis of steering information of the steering wheel 81, is transmitted to the rack bar 84 through the pulley 87 and the belt 86.

The steering system 80 may perform basic assistance control on the steering motor 88 so that the amount of basic assistance of the steering motor 88 is adjusted depending on steering information. In this case, the rack bar 84 may move the tie rod 84b while being moved in the axial direction of the rack bar by the rotational force corresponding to the amount of basic assistance of the steering motor 88.

The rack bar 84 changes traveling directions of the wheels 11 and 12 by being rectilinearly moved by the moving force transmitted from the pinion gear 83 and the rack gear 84a and the moving force transmitted from the ball nut 85.

The steering system 80 may include a steering sensor 90 configured to detect a rotation of the steering wheel 81.

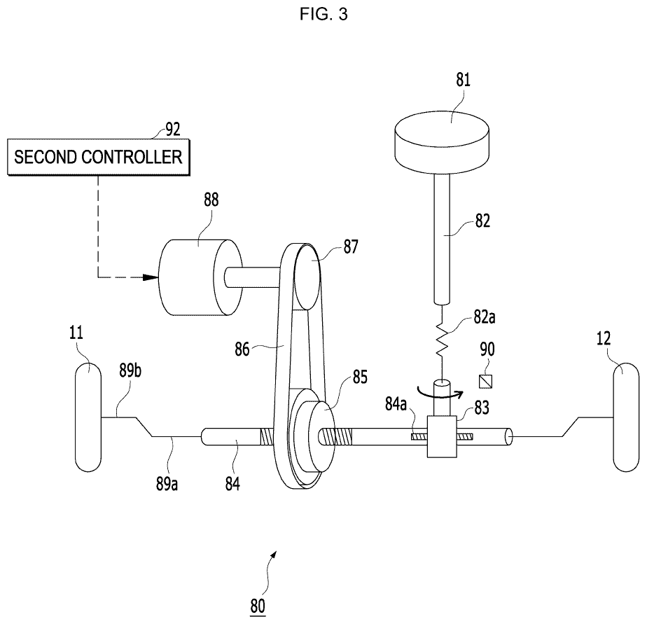

With reference to FIG. 3, a plurality of wheel speed sensors 61, 62, 63, and 64 output wheel speed signals, which respectively indicate the rotational speeds of the plurality of wheels 11, 12, 13, and 14, through first channels A and second channels B and provide the wheel speed signals to at least one of a first controller 150 and the second controller 92.

Specifically, the plurality of wheel speed sensors 61, 62, 63, and 64 may each output the wheel speed signal through the first channel A and provide the wheel speed signal to the first controller 150. In order to implement redundancy, the plurality of wheel speed sensors 61, 62, 63, and 64 may each additionally provide a wheel speed signal to the second controller 92 through the second channel B.

The brake system 100 may include a plurality of brake modules 110, 120, 130, and 140 respectively installed in the plurality of wheels 11, 12, 13, and 14, and the first controller 150 configured to perform braking control related to the plurality of brake modules 110, 120, 130, and 140.

The plurality of brake modules 110, 120, 130, and 140 may respectively brake the plurality of wheels 11, 12, 13, and 14, thereby braking the vehicle 1. For example, the plurality of brake modules 110, 120, 130, and 140 may include a first brake module 110 configured to brake the first wheel 11, a second brake module 120 configured to brake the second wheel 12, a third brake module 130 configured to brake the third wheel 13, and/or a fourth brake module 140 configured to brake the fourth wheel 14. However, the number of brake modules 110, 120, 130, and 140 is not limited to four.

The plurality of brake modules 110, 120, 130, and 140 may be provided as hydraulic brakes configured to be operated by liquid pressure to brake the plurality of wheels 11, 12, 13, and 14. In this regard, the brake system 100 may include a liquid pressure supply module 200 configured to provide liquid pressure to the plurality of brake modules 110, 120, 130, and 140 through a liquid pressure line HL.

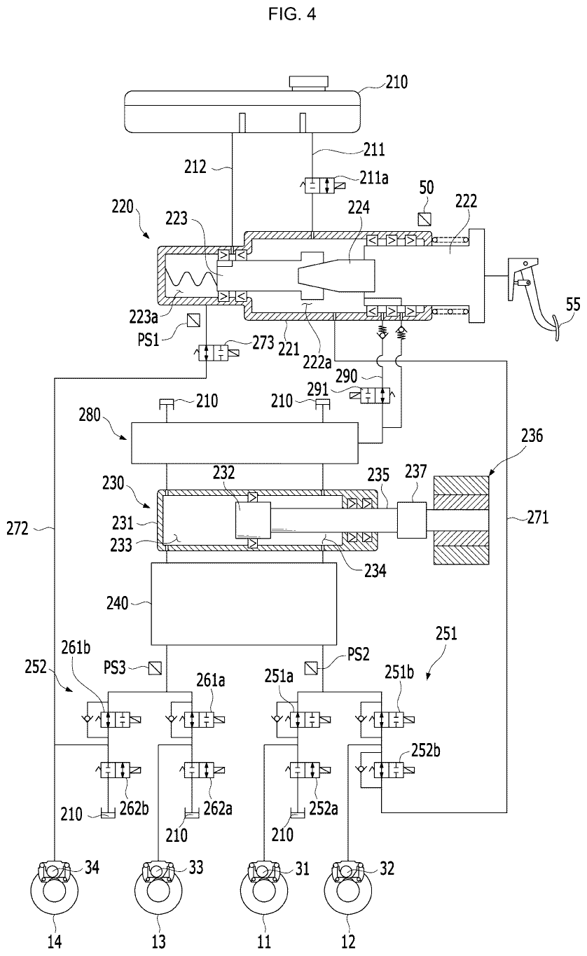

With reference to FIG. 4, the liquid pressure supply module 200 may generate liquid pressure for braking the first to fourth wheels 11, 12, 13, and 14 and provide the liquid pressure to the first to fourth brake modules 110, 120, 130, and 140.

Specifically, the liquid pressure supply module 200 may include a reservoir 210 configured to store a pressing medium, a master cylinder 220 configured to provide the driver with a reaction force corresponding to a pedal effort of the brake pedal 55 and pressurize and discharge the pressing medium such as brake oil accommodated therein, a liquid pressure supply unit 230 configured to generate liquid pressure of the pressing medium by means of a mechanical operation by receiving the driver's braking intention as an electrical signal from the pedal displacement sensor 50 configured to detect a displacement of the brake pedal 55, a hydraulic control unit 240 configured to control the liquid pressure provided from the liquid pressure supply unit 230, a hydraulic pressure circuit 250 having wheel cylinders 31 and 32 configured to brake the wheels 11, 12, 13, and 14 by receiving the liquid pressure of the pressing medium, a back-up flow path 271 configured to hydraulically connect the master cylinder 220 and the hydraulic pressure circuit 250, a dump control unit 280 provided between the liquid pressure supply unit 230 and the reservoir 210 and configured to control a flow of the pressing medium, reservoir flow paths 211 and 212 configured to hydraulically connect the reservoir 210 and the master cylinder 220, and an inspection flow path 290 connected to a master chamber of the master cylinder 220.

The reservoir 210, the master cylinder 220, the liquid pressure supply unit 230, the hydraulic control unit 240, the hydraulic pressure circuit 250, the back-up flow path 271, the dump control unit 280, the reservoir flow paths 211 and 212, and the inspection flow path 290 are not essential components and all or at least some of the above-mentioned components may be excluded.

The reservoir 210 may accommodate and/or store the pressing medium therein. The reservoir 210 may be connected to the master cylinder 220, the liquid pressure supply unit 230, and/or the hydraulic pressure circuit 250 and supply or receive the pressing medium.

The reservoir flow paths 211 and 212 may include a first reservoir flow path 211 configured to connect a first master chamber 222a of the master cylinder 220 and the reservoir 210, and a second reservoir flow path 212 configured to connect a second master chamber 223a of the master cylinder 220 and the reservoir 210. A simulator valve 211a may be provided in the first reservoir flow path 211 and control the flow of the pressing medium between the reservoir 210 and the first master chamber 222a through the first reservoir flow path 211.

In case that the driver applies a pedal effort to the brake pedal 55 to perform the braking operation, the master cylinder 220 may provide stable pedal feel by providing the driver with a reaction force corresponding to the pedal effort. In addition, the master cylinder 220 may be configured to pressurize and discharge the pressing medium accommodated therein by the operation of the brake pedal 55.

The master cylinder 220 may include a cylinder body 221 configured to define a chamber therein, the first master chamber 222a formed at an inlet side of the cylinder body 221 to which the brake pedal 55 is connected, a first master piston 222 provided in the first master chamber 222a, connected to the brake pedal 55, and configured to be displaced by the operation of the brake pedal 55, the second master chamber 223a formed on the cylinder body 221 and formed inward or forward (leftward based on FIG. 4) of the first master chamber 222a, a second master piston 223 provided in the second master chamber 223a and configured to be displaced by the displacement of the first master piston 222 or the liquid pressure of the pressing medium accommodated in the first master chamber 222a, and a pedal simulator 224 disposed between the first master piston 222 and the second master piston 223 and configured to provide pedal feel by means of an elastic restoring force generated by compression.

The cylinder body 221, the first master chamber 222a, the first master piston 222, the second master chamber 223a, the second master piston 223, and the pedal simulator 224 are not essential components, and all or at least some of the above-mentioned components may be excluded.

The first master piston 222 and the second master piston 223 may be respectively provided in the first master chamber 222a and the second master chamber 223a and form liquid pressure or negative pressure in the pressing medium accommodated in the chambers while moving forward and rearward.

The pedal simulator 224 may be provided between the first master piston 222 and the second master piston 223 and provide the pedal feel of the brake pedal 55 to the driver by the elastic restoring force thereof.

The liquid pressure supply unit 230 may be configured to generate the liquid pressure of the pressing medium by the mechanical operation by receiving the driver's braking intention as an electrical signal from the pedal displacement sensor 50 configured to detect the displacement of the brake pedal 55.

The liquid pressure supply unit 230 may include a cylinder block 231 configured to accommodate the pressing medium, a hydraulic piston 232 accommodated in the cylinder block 231, pressure chambers 233 and 234 separated by the hydraulic piston 232 and the cylinder block 231, a liquid pressure generation motor 236 configured to generate a rotational force, a power conversion unit 237 configured to convert the rotational force of the liquid pressure generation motor 236 into a translational movement of the hydraulic piston 232, and a driving shaft 235 configured to transmit power to the hydraulic piston 232.

The cylinder block 231, the hydraulic piston 232, the pressure chambers 233 and 234, the liquid pressure generation motor 236, the power conversion unit 237, and the driving shaft 235 are not essential components of the liquid pressure supply unit 230, and at least some of the above-mentioned components may be excluded.

The pressure chambers 233 and 234 may include a first pressure chamber 233 positioned forward of the hydraulic piston 232 (leftward of the hydraulic piston 232 based on FIG. 4), and a second pressure chamber 234 positioned rearward of the hydraulic piston 232 (rightward of the hydraulic piston 232 based on FIG. 4). That is, the first pressure chamber 233 may be provided and defined by the cylinder block 231 and a front surface of the hydraulic piston 232, and a volume of the first pressure chamber 233 may change as the hydraulic piston 232 moves. In addition, the second pressure chamber 234 may be provided and defined by the cylinder block 231 and a rear surface of the hydraulic piston 232, and a volume of the second pressure chamber 234 may change as the hydraulic piston 232 moves.

When the pedal displacement sensor 50 detects the displacement of the brake pedal 55, the hydraulic piston 232 may generate the liquid pressure in the first pressure chamber 233 and generate the negative pressure in the second pressure chamber 234 while moving forward in the cylinder block 231. On the contrary, when the pedal effort of the brake pedal 55 is eliminated, the hydraulic piston 232 may generate the negative pressure in the first pressure chamber 233 and generate the liquid pressure in the second pressure chamber 234 while moving rearward in the cylinder block 231.

As described above, the liquid pressure generation motor 236 of the liquid pressure supply unit 230 may generate the liquid pressure or the negative pressure in each of the first pressure chamber 233 and the second pressure chamber 234.

The liquid pressure supply unit 230 may be hydraulically connected to the reservoir 210 by the dump control unit 280. The dump control unit 280 may include at least one flow path and at least one valve to control the flow of the pressing medium between the liquid pressure supply unit 230 and the reservoir 210.

The hydraulic control unit 240 may be configured to control the liquid pressure to be transmitted to the wheel cylinders 31, 32, 33, and 34.

The hydraulic control unit 240 may be connected to first and second hydraulic circuits 251 and 252 configured to control the flow of the liquid pressure to be transmitted to the first to fourth wheels cylinders 31, 32, 33, and 34.

The hydraulic control unit 240 may include a plurality of flow paths and a plurality of valves to guide the hydraulic pressure, which is supplied from the liquid pressure supply unit 230, to the first and second hydraulic circuits 251 and 252.

The hydraulic control unit 240 may define a flow path for providing the pressing medium to the first and second hydraulic circuits 251 and 252 by using the pressure in the first pressure chamber 233 generated by the forward movement of the hydraulic piston 232. For example, the hydraulic control unit 240 may define a flow path configured to connect the first pressure chamber 233 and the first and second hydraulic circuits 251 and 252. The pressing medium in the first pressure chamber 233 may be provided to the first and second hydraulic circuits 251 and 252 by means of the hydraulic control unit 240.

The hydraulic control unit 240 may define a flow path for providing the pressing medium to the first and second hydraulic circuits 251 and 252 by using the pressure in the second pressure chamber 234 generated by the rearward movement of the hydraulic piston 232. For example, the hydraulic control unit 240 may define a flow path configured to connect the second pressure chamber 234 and the first and second hydraulic circuits 251 and 252. The pressing medium in the second pressure chamber 234 may be provided to the first and second hydraulic circuits 251 and 252 by means of the hydraulic control unit 240.

The hydraulic control unit 240 may define a flow path for recovering the pressing medium from the first and second hydraulic circuits 251 and 252 by using the negative pressure in the first pressure chamber 233 generated by the rearward movement of the hydraulic piston 232. For example, the hydraulic control unit 240 may define a flow path configured to connect a first hydraulic circuit 251 and the first pressure chamber 233 and connect a second hydraulic circuit 252 and the first pressure chamber 233. The pressing medium in the first and second hydraulic circuits 251 and 252 may be provided to the first pressure chamber 233 through the hydraulic control unit 240.

The hydraulic control unit 240 may define a flow path for recovering the pressing medium from the first and second hydraulic circuits 251 and 252 by using the negative pressure in the second pressure chamber 234 generated by the forward movement of the hydraulic piston 232. For example, the hydraulic control unit 240 may define a flow path configured to connect the first hydraulic circuit 251 and the second pressure chamber 234 and connect the second hydraulic circuit 252 and the second pressure chamber 234. The pressing medium in the first and second hydraulic circuits 251 and 252 may be provided to the second pressure chamber 234 through the hydraulic control unit 240.

The first hydraulic circuit 251 may adjust and/or control the liquid pressure to be applied to the first and second wheel cylinders 31 and 32, and the second hydraulic circuit 252 may adjust and/or control the liquid pressure to be applied to the third and fourth wheel cylinders 33 and 34.

The first hydraulic circuit 251 may have first and second inlet valves 251a and 251b respectively disposed at upstream sides of the first and second wheel cylinders 31 and 32 and configured to control a flow of the pressing medium and the liquid pressure to be transmitted to the first and second wheel cylinders 31 and 32. The first and second inlet valves 251a and 251b may each be provided as a normal open-type solenoid valve.

In addition, the first hydraulic circuit 251 may include first and second outlet valves 252a and 252b configured to control a flow of the pressing medium discharged from the first and second wheel cylinders 31 and 32 in order to improve performance when the first and second wheel cylinders 31 and 32 perform braking release operations.

The first outlet valve 252a may be disposed at a discharge side of the first wheel cylinder 31 and control a flow of the pressing medium to be transmitted from the first wheel cylinder 31 to the reservoir 210. The first outlet valve 252a may be provided as a normal closed-type solenoid valve.

The second outlet valve 252b may be connected to (or provided in) a first back-up flow path 271 corresponding to a discharge side of the second wheel cylinder 32 and control a flow of the pressing medium between the second wheel cylinder 32 and the master cylinder 220. However, the connection structure of the first back-up flow path 271 is not limited thereto. For example, the first back-up flow path 271 may be connected to the first wheel cylinder 31. In addition, the first back-up flow path 271 may be connected to the first wheel cylinder 31 and the second wheel cylinder 32. As described above, the first back-up flow path 271 may be connected to at least one of the first wheel cylinder 31 and the second wheel cylinder 32. The second outlet valve 252b may be provided as a normal open-type solenoid valve.

The second hydraulic circuit 252 may have third and fourth inlet valves 261a and 261b respectively disposed at upstream sides of the third and fourth wheel cylinders 33 and 34 and configured to control a flow of the pressing medium and the liquid pressure to be transmitted to the third and fourth wheel cylinders 33 and 34. The third and fourth inlet valves 261a and 261b may each be provided as a normal open-type solenoid valve.

In addition, the second hydraulic circuit 252 may include third and fourth outlet valves 262a and 262b configured to control a flow of the pressing medium discharged from the third and fourth wheel cylinders 33 and 34 in order to improve performance when the third and fourth wheel cylinders 33 and 34 perform braking release operations.

The third outlet valve 262a may be provided at a discharge side of the third wheel cylinder 33 and control a flow of the pressing medium to be transmitted from the third wheel cylinder 33 to the reservoir 210. The third outlet valve 262a may be provided as a normal closed-type solenoid valve.

The fourth outlet valve 262b may be provided at a discharge side of the fourth wheel cylinder 34 and control a flow of the pressing medium to be transmitted from the fourth wheel cylinder 34 to the reservoir 210. The fourth outlet valve 262b may be provided as a normal closed type solenoid valve.

A cut valve 273 may be provided in a second back-up flow path 272 corresponding to a discharge side of the fourth wheel cylinder 34 and control a flow of the pressing medium between the fourth wheel cylinder 34 and the master cylinder 220.

However, the connection structure of the second back-up flow path 272 is not limited thereto. For example, the second back-up flow path 272 may be connected to the third wheel cylinder 33. In addition, the second back-up flow path 272 may be connected to the third wheel cylinder 33 and the fourth wheel cylinder 34. As described above, the second back-up flow path 272 may be connected to at least one of the third wheel cylinder 33 and the fourth wheel cylinder 34.

In case that the liquid pressure supply module 200 cannot normally operate because of a failure or the like, at least one of the first back-up flow path 271 and the second back-up flow path 272 may be configured to transmit the liquid pressure in the master cylinder 220 directly to the wheel cylinders 31, 32, 33, and 34 in an abnormal operating mode, i.e., a fallback mode. For example, the first back-up flow path 271 may be provided to connect the first master chamber 222a of the master cylinder 220 and the first hydraulic circuit 251, and the second back-up flow path 272 may be provided to connect the second master chamber 223a of the master cylinder 220 and the second hydraulic circuit 252.

The inspection flow path 290 may be provided to connect the master cylinder 220 and the dump control unit 280 and provided to inspect whether the simulator valve 211a and various types of component elements mounted in the master cylinder 220 leak.

The liquid pressure supply module 200 may include a first pressure sensor PS1 configured to measure the liquid pressure provided by the master cylinder 220, and second and third pressure sensors PS2 and PS3 configured to measure the liquid pressure of the pressing medium provided by the liquid pressure supply unit 230. The first pressure sensor PS1, the second pressure sensor PS2, and the third pressure sensor PS3 may output electrical signals representing the measured pressure.

With reference back to FIG. 1, the first controller 150 may receive output signals from the pedal displacement sensor 50, the wheel speed sensor 60, the motion sensor 70, and/or the steering system 80 and perform the braking control related to the plurality of brake modules 110, 120, 130, and 140 in response to the received signals.

The first controller 150 may provide a braking control signal to the liquid pressure supply module 200 to brake the vehicle 1 in response to at least one of the electrical signal outputted from the pedal displacement sensor 50 and the electrical signal outputted from the wheel speed sensor 60. For example, the first controller 150 may identify a braking force (or braking acceleration) for braking the vehicle 1 in response to the output signal from the pedal displacement sensor 50 and provide the liquid pressure supply module 200 with the braking control signal corresponding to the identified braking force (or braking acceleration).

The first controller 150 may provide the braking control signal to the liquid pressure supply module 200 to temporarily allow the rotations of the plurality of wheels 11, 12, 13, and 14 in response to the electrical signal outputted from the wheel speed sensor 60. For example, the first controller 150 may identify slips of all or some of the plurality of wheels 11, 12, 13, and 14 in response to the output signal from the wheel speed sensor 60 while the vehicle 1 is braked. The brake controllers 150 and 160 may provide the liquid pressure supply module 200 with the braking control signal that temporarily allows the rotations of the plurality of wheels 11, 12, 13, and 14 in order to eliminate the slips of the plurality of wheels 11, 12, 13, and 14 in response to the slips of the plurality of wheels 11, 12, 13, and 14. In this regard, the brake system 100 may perform an anti-lock braking system (ABS) function.

The first controller 150 may provide the braking control signal to the liquid pressure supply module 200 in order to temporarily brake the plurality of wheels 11, 12, 13, and 14 in response to the electrical signal outputted from the wheel speed sensor 60 without the user's braking intention. For example, the first controller 150 may identify spins of the plurality of wheels 11, 12, 13, and 14 in response to the output signal from the wheel speed sensor 60 while the vehicle 1 travels. The first controller 150 may provide the liquid pressure supply module 200 with the braking control signal for temporarily braking the plurality of wheels 11, 12, 13, and 14 in order to eliminate the spins of the plurality of wheels 11, 12, 13, and 14 in response to the spins of the plurality of wheels 11, 12, 13, and 14. In this regard, the brake system 100 may perform a traction control system (TCS) function.

The first controller 150 may provide the braking control signal to the liquid pressure supply module 200 in order to temporarily brake the plurality of wheels 11, 12, 13, and 14 in response to the electrical signal outputted from the motion sensor 70 and/or the steering sensor 90 without the user's braking intention. For example, the first controller 150 may identify a reference route (reference rotation traveling route) of the vehicle 1 in response to an output signal from the steering sensor 90 while the vehicle 1 is steered, and the first controller 150 may identify a traveling route (rotation traveling route) of the vehicle 1 in response to an output signal of the motion sensor 70 while the vehicle 1 is steered. The first controller 150 may identify oversteering or understeering of the vehicle 1 on the basis of the reference route and the traveling route. The first controller 150 may provide the liquid pressure supply module 200 with the braking control signal for temporarily braking the plurality of wheels 11, 12, 13, and 14 on the basis of the oversteering and/or the understeering. In this regard, the brake system 100 may perform an electronic stability control (ESC) function.

The first controller 150 and the second controller 92 may include a plurality of semiconductor elements and be called various terms such as a brake control unit (BCU) and an electronic control unit (ECU). For example, the first controller 150 and the second controller 92 may each include at least one processor 151 or 93 and/or at least one memory 152 or 94. For example, the first controller 150 may include a first processor 151 and a first memory 152. In addition, the second controller 92 may include a second processor 93 and a second memory 94. The above-mentioned components are not essential components of the brake system 100, and at least some of the above-mentioned components may be excluded.

The first controller 150 may include a first driver circuit 153 configured to control the liquid pressure generation motor 236 to allow the liquid pressure supply module 200 to supply the liquid pressure to at least one of the plurality of brake modules 110, 120, 130, and 140 in response to a control signal outputted from the first processor 151.

The second controller 92 may include a second driver circuit 95 configured to control the steering motor 88 configured to provide driving power in the steering system 80 in response to a control signal outputted from the second processor 93, and a third driver circuit 96 configured to control an EPB motor 341 that will be described below and is configured to provide driving power in electronic parking brakes 181 and 182 in response to the control signal outputted from the second processor 93.

The first processor 151 may perform the braking control on at least one of the plurality of brake modules 110, 120, 130, and 140. The second processor 93 may control at least one of the steering system 80 and the electronic parking brakes 181 and 182.

The first memory 152 may store or memorize programs and data for implementing operations of controlling the components included in the brake system 100.

The second memory 94 may store or memorize programs and data for implementing operations of controlling the components included in the steering system 80.

The first and second memories 152 and 94 may provide the stored program and data to the first and second processors 151 and 93 and memorize temporary data produced during the operations of the first and second processors 151 and 93. For example, the first and second memories 152 and 94 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The first controller 150 may perform preset computation in response to output signals from the pedal displacement sensor 50 and/or the wheel speed sensor 60. In addition, the first controller 150 may identify a braking force (or braking acceleration or fastening force) corresponding to the service brake, the ABS, the TSC, the ESC, and the like on the basis of the executed computation and output a braking control signal, which corresponds to the braking force, to all or some of the plurality of brake modules 110, 120, 130, and 140.

The first controller 150 may receive a first pedal displacement signal PTS1 from the pedal displacement sensor 50 and receive first to fourth wheel speed signals WSS1, WSS2, WSS3, and WSS4 from the first to fourth wheel speed sensors 61, 62, 63, and 64. In addition, the first controller 150 may control the liquid pressure supply module 200 configured to provide the liquid pressure to the first to fourth brake modules 110, 120, 130, and 140 to brake the first to fourth wheels 11, 12, 13, and 14.

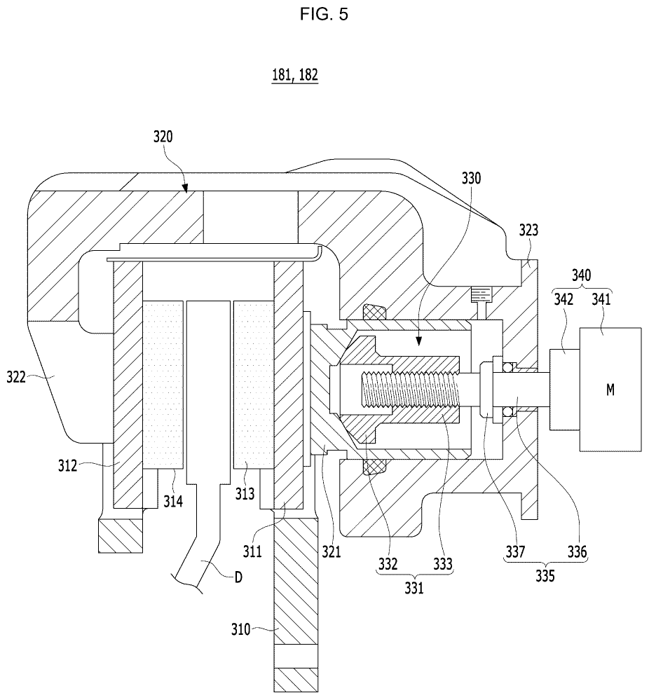

FIG. 5 is a view illustrating an example of the electronic parking brake according to the embodiment of the disclosed disclosure.

With reference to FIG. 5, the electronic parking brakes 181 and 182 may each include a carrier 310 on which a pair of pad plates 311 and 312, which are installed to press a brake disc D configured to rotate together with the third wheel 13 and the fourth wheel 14, are installed to be advanced or retracted, a caliper housing 320 slidably installed on the carrier 310 and having a cylinder 323 in which a piston 321 is installed to be advanced or retracted by hydraulic braking pressure, a power conversion unit 330 configured to press the piston 321, and a motor actuator 340 configured to transmit a rotational force to the power conversion unit 330 by using an EPB motor 141.

The pair of pad plates 311 and 312, the caliper housing 320, the piston 321, the power conversion unit 330, and the motor actuator 340 are not essential components, and all or at least some of the above-mentioned components may be excluded.

The piston 321 may be provided in a cup shape opened at a rear side (right side in FIG. 5) and slidably inserted into the cylinder 323. In addition, the piston 321 may press the inner pad plate 311 toward the brake disc D by receiving power through the power conversion unit 330.

The power conversion unit 330 may serve to receive the rotational force from the actuator 340 and press the piston 321 toward the inner pad plate 311.

The power conversion unit 330 may include a nut member 331 disposed and installed in the piston 321 and provided to be in contact with the piston 321, and a spindle member 335 screw-coupled to the nut member 331.

The nut member 331 may be disposed in the piston 321 in a state in which a rotation of the nut member 331 is restricted, and the nut member 331 may be screw-coupled to the spindle member 335.

The nut member 331 may include a head portion 332 configured to adjoin the piston 321, and a coupling portion 333 extending from the head portion 332 and having an internal thread formed on an inner peripheral surface thereof so that the nut member 331 is screw-coupled to the spindle member 335.

The nut member 331 may serve to press or release the piston 321 while moving in a forward or rearward direction in accordance with a rotation direction of the spindle member 335. In this case, the forward direction may be a movement direction in which the nut member 331 approaches the piston 321. The rearward direction may be a movement direction in which the nut member 331 moves away from the piston 321. In addition, the forward direction may be a movement direction in which the piston 321 approaches brake pads 313 and 314. The rearward direction may be a movement direction in which the piston 321 moves away from the brake pads 313 and 314.

The spindle member 335 may include a shaft portion 336 configured to penetrate a rear portion of the caliper housing 320 and configured to rotate by receiving a rotational force from the EPB actuator 340, and a flange portion 337 extending from the shaft portion 336 in a radial direction. One side of the shaft portion 336 may penetrate a rear side of the cylinder 323 and be rotatably installed, and the other side of the shaft portion 336 may be disposed in the piston 321. In this case, one side of the shaft portion 336, which penetrates the cylinder 323, may be connected to an output shaft of a speed reducer 342 and receive the rotational force from the EPB actuator 340.

The EPB actuator 340 may include the EPB motor 341 and the speed reducer 342.

The EPB motor 341 may press or release the piston 321 by advancing or retracting the nut member 331 by rotating the spindle member 335.

The speed reducer 342 may be provided between an output side of the EPB motor 341 and the spindle member 335.

The electronic parking brakes 181 and 182 may include a first electronic parking brake 181 installed in the third wheel 13, and a second electronic parking brake 182 installed in the fourth wheel 14.

In order to engage the EPB, the first and second electronic parking brakes 181 and 182 may move the nut member 331 to press the piston 321 by rotating the spindle member 335 in one direction by using the EPB actuator 340. The piston 321, which is pressed by the movement of the nut member 331, presses the inner pad plate 311 to attach the brake pads 313 and 314 tightly to the brake disc D, such that a fastening operation of generating a fastening force may be performed.

In addition, during a parking release process, the first and second electronic parking brakes 181 and 182 may retract the nut member 331, which has been pressed by the piston 321, by rotating the spindle member 335 in a reverse direction by using the EPB actuator 340. The nut member 331 is released from the piston 321 by the retraction of the nut member 331.

With reference back to FIG. 1, the first controller 150 and the second controller 92 may be connected by a first internal communication network CAN1 and send and receive signals for identifying states thereof.

In addition, the first controller 150 and the second controller 92 may be connected by a second internal network CAN2 and send and receive signals for identifying states thereof.

As described above, the first controller 150 and the second controller 92 are connected by the dualized internal communication networks CAN1 and CAN2, such that the states of the first controller 150 and the second controller 92 may be monitored by a normal internal communication network even though any one internal communication network fails.

The first internal communication network CAN1 and the second internal communication network CAN2 may use various communication methods such as Ethernet, media-oriented system transport (MOST), a universal asynchronous receiver/transmitter (UART), Flexray, a controller area network (CAN), and a local interconnect network (LIN).

The first controller 150 may periodically transmit a status signal to the second controller 92. The second controller 92 may identify a normal operating state of the first controller 150 on the basis of a result of receiving the periodic status signal by the first controller 150.

In case that the first controller 150 does not operate normally, the first controller 150 may not transmit the periodic status signal to the second controller 92. The second controller 92 may identify an abnormal operating state (e.g., damage, error, reset, power cut off, or the like) of the first controller 150 at a predetermined cycle on the basis of a situation in which the first controller 150 does not receive the periodic status signal.

The second controller 92 may output electrical signals, which correspond to the service brake, the EPB, and the like, to the first and second electronic parking brakes 181 and 182 on the basis of the result of identifying the abnormal operating state (e.g., damage, error, reset, power cut off, or the like) of the first controller 150.

The second controller 92 may perform preset computation in response to the output signals from the pedal displacement sensor 50, the wheel speed sensor 60, the motion sensor 50, and/or the steering sensor 90. In addition, the second controller 92 may identify a braking force corresponding to the service brake, the EPB, and the like on the basis of the executed computation.

The second controller 92 may receive a second pedal displacement signal PTS2 from the pedal displacement sensor 50 and receive the first to fourth wheel speed signals WSS1, WSS2, WSS3, and WSS4 from the first to fourth wheel speed sensors 61, 62, 63, and 64.

The second controller 92 may provide the first and second electronic parking brakes 181 and 182 with braking control signals representing braking torque (or braking force, braking acceleration (deceleration), or fastening force (clamping force)). For example, the second controller 92 may identify the braking torque required by the driver in response to the second pedal signal PTS2 and provide a braking control signal to perform service brake functions of the first and second electronic parking brakes 181 and 182 on the basis of the braking torque required by the driver.

The pedal displacement sensor 50 may include a first pedal displacement sensor 51 and a second pedal displacement sensor 52 in order to prepare for damage to or an error of an electric system.

The first pedal displacement sensor 51 and the second pedal displacement sensor 52 may each detect a movement of the brake pedal 55 and output the electrical output signals PTS1 and PTS2, which correspond to the movement (e.g., a movement displacement and/or a movement speed) of the brake pedal 55, to the first controller 150 and the second controller 92. For example, the first pedal displacement sensor 51 may be electrically connected to the first controller 150 and output the first pedal displacement signal PTS1 to the first controller 150. The second pedal displacement sensor 52 may be electrically connected to the second controller 92 and output the second pedal displacement signal PTS2 to the second controller 92.

The wheel speed sensor 60 may include the plurality of wheel speed sensors 61, 62, 63, and 64 respectively installed in the plurality of wheels 11, 12, 13, and 14. For example, the wheel speed sensor 60 may include the first to fourth wheel speed sensors 61, 62, 63, and 64.

The first to fourth wheel speed sensors 61, 62, 63, and 64 may independently detect the rotational speeds of the first to fourth wheels 11, 12, 13, and 14. In addition, the first to fourth wheel speed sensors 61, 62, 63, and 64 may be electrically connected to the brake system 100 and output the electrical signals WSS1, WSS2, WSS3, and WSS4, which correspond to the rotational speeds of the first to fourth wheels 11, 12, 13, and 14, to the brake controllers 150 and 160.

The first to fourth wheel speed sensors 61, 62, 63, and 64 may output the first to fourth wheel speed signals WSS1, WSS2, WSS3, and WSS4 to multiple channels to prepare for damage to or an error of the electric system.

For example, the first to fourth wheel speed sensors 61, 62, 63, and 64 may output the first to fourth wheel speed signals WSS1, WSS2, WSS3, and WSS4, which correspond to the rotational speeds of the first to fourth wheels 11, 12, 13, and 14, to the first controller 150 through the first channels A. The first controller 150 may receive, through the first channels A, the first to fourth wheel speed signals WSS1, WSS2, WSS3, and WSS4 outputted from the first to fourth wheel speed sensors 61, 62, 63, and 64.

In addition, the first wheel speed sensor 61 and the second wheel speed sensor 62 may output the first wheel speed signal WSS1 and the second wheel speed signal WSS2 to the second controller 92 through the second channels. In addition, the third wheel speed sensor 63 and the fourth wheel speed sensor 64 may output the third wheel speed signal WSS3 and the fourth wheel speed signal WSS4 to the third brake module 130 and the fourth brake module 140 in order to prepare for damage to or an error of the electric system. The first to fourth wheel speed sensors 61, 62, 63, and 64 may output the wheel speed signals to the plurality of channels so that a breakdown, such as disconnection, does not affect the safety of the vehicle.

The first controller 150 and the second controller 92 may receive, through the preset channels, the first to fourth wheel speed signals WSS1, WSS2, WSS3, and WSS4 outputted from the first to fourth wheel speed sensors 61, 62, 63, and 64 and perform the braking control on at least one of the first to fourth wheels 11, 12, 13, and 14 in response to the received wheel speed signals.

The first controller 150 and the second controller 92 may identify a communication state (e.g., a normal state or a failure state) on the basis of whether the first to fourth wheel speed signals WSS1, WSS2, WSS3, and WSS4 outputted from the first to fourth wheel speed sensors 61, 62, 63, and 64 are received.

When a communication failure is identified as the first controller 150 cannot receive at least one of the first to fourth wheel speed signals WSS1, WSS2, WSS3, and WSS4 from the first to fourth wheel speed sensors 61, 62, 63, and 64, the first controller 150 may perform the braking control on the first to fourth brake modules 110, 120, 130, and 140 by using the wheel speed signal received by the second controller 92.

When a communication failure is identified as the first controller 150 cannot receive at least one of the third and fourth wheel speed signals WSS3 and WSS4 from the third and fourth wheel speed sensors 63 and 64, the second controller 92, instead of the first controller 150, may perform the braking control on the first and second electronic parking brakes 181 and 182.

For example, when a communication failure is identified as the first controller 150 cannot receive at least one of the third wheel speed signal WSS3 and the fourth wheel speed signal WSS4 from at least one of the third wheel speed sensor 63 and the fourth wheel speed sensor 64, the second controller 92, which receives at least one of the third wheel speed signal WSS3 and the fourth wheel speed signal WSS4 from at least one of the third wheel speed sensor 63 and the fourth wheel speed sensor 64 may perform the service brake function by using the first and second electronic parking brakes 181 and 182, instead of the first controller 150.

When a failure of the first controller 150 is identified on the basis of whether the first controller 150 receives the periodic status signal, the second controller 92 may perform at least one of the parking brake function and the service brake function by using the first and second electronic parking brakes 181 and 182 in response to the first to fourth wheel speed signals WSS1, WSS2, WSS3, and WSS4 outputted from the first to fourth wheel speed sensors 61, 62, 63, and 64.

An EPB switch 190 may output a signal (operating signal) generated by the user's manipulation. The second controller 92 may receive an operating signal from the EPB switch 190 and perform the braking control on the first and second electronic parking brakes 181 and 182 in response to at least one of the operating signal of the EPB switch 190, the second pedal displacement signal PTS2, and the first to fourth wheel speed signals WSS1, WSS2, WSS3, and WSS4.

In the brake system according to the embodiment of the present disclosure, the second controller, which controls the steering system, may independently perform the service brake function and the parking brake function by using the electronic parking brake.

Therefore, it is possible to ensure the redundancy capable of coping with the failure of the controller, which performs the braking control on the hydraulic brake module, and to prevent an increase in costs and an addition of processes due to the addition of other devices. In addition, the controller may receive, through the multiple channels, the wheel speed signals from the wheel speed sensors respectively installed in the wheels and implement the redundancy for preparing for an erroneous braking situation.

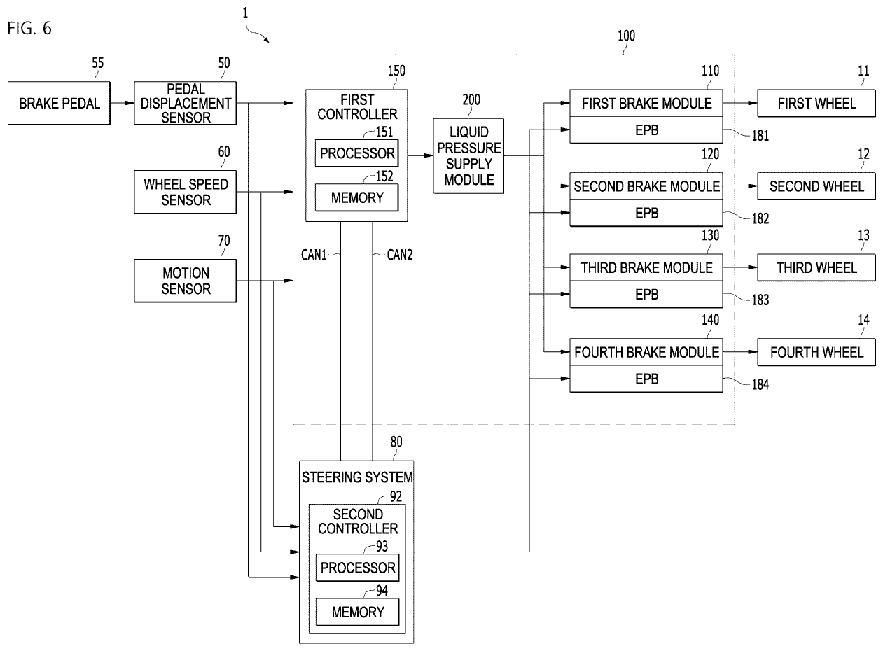

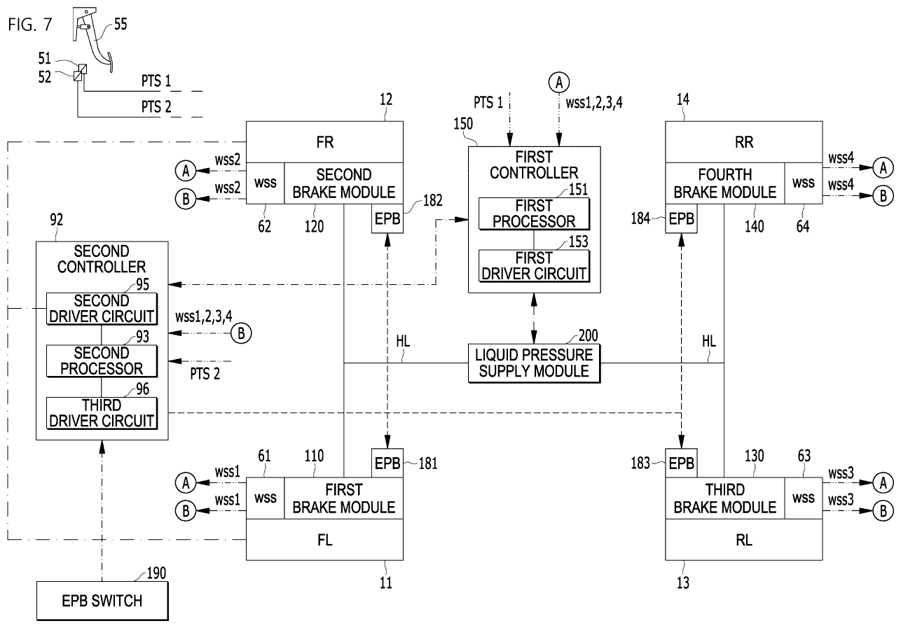

FIG. 6 is a view illustrating a configuration of a brake system according to a second embodiment of the disclosed disclosure. FIG. 7 is a view illustrating a connection relationship between components included in the brake system according to the second embodiment of the disclosed disclosure.

In this case, in order to avoid the repeated description, the description will focus on first to fourth electronic parking brakes 181, 182, 183, and 184 added to the first embodiment.

With reference to FIGS. 6 and 7, the brake system 100 may include the first to fourth electronic parking brakes 181, 182, 183, and 184 respectively installed in the plurality of wheels 11, 12, 13, and 14.

The second controller 92 may identify an operating state (e.g., a normal state or a failure state) of the first controller 150 on the basis of whether the first controller 150 receives a periodic status signal.

When a failure of the first controller 150 is identified, the second controller 92 may output braking control signals for controlling the operations of the first and second electronic parking brakes 181 and 182 to the first and second electronic parking brakes 181 and 182 through a third internal communication network CAN3 and output braking control signals for controlling the operations of the third and fourth electronic parking brakes 81 and 82 through a fourth internal communication network CAN4 to the first and second electronic parking brakes 181 and 182.

Even though the failure of the first controller 150 is identified, the second controller 92 may stably perform at least one of the service brake function and the parking brake function of the vehicle 1 by using the first to fourth electronic parking brakes 181, 182, 183, and 184.

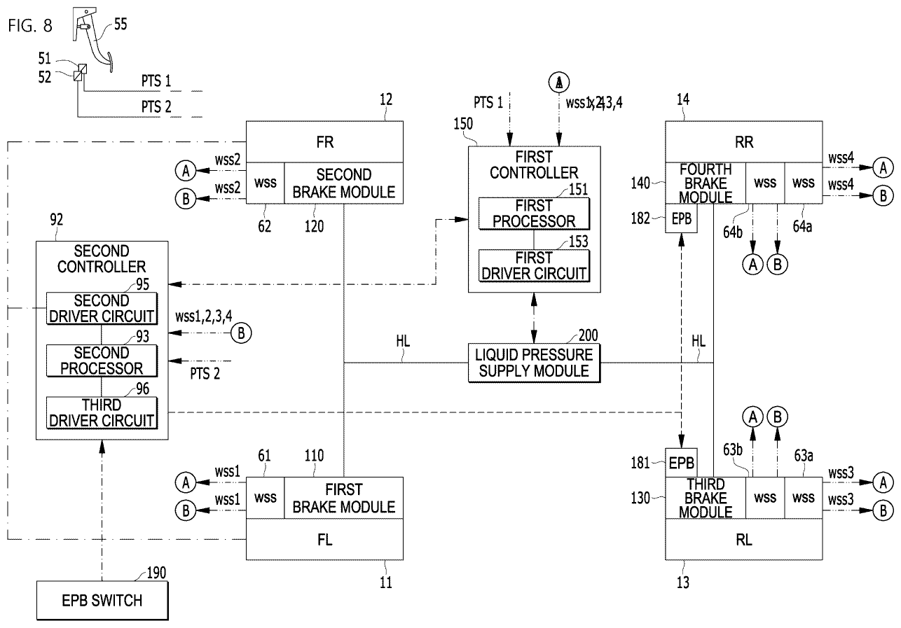

FIG. 8 is a view illustrating a connection relationship between components included in a brake system according to a third embodiment of the disclosed disclosure.

In this case, in order to avoid the repeated description, the description will focus on first and second left rear wheel (RL) wheel speed sensors 63a and 63b and first and second right rear wheel (RR) wheel speed sensors 64a and 64b added to the first embodiment.

With reference to FIG. 8, the third wheel speed sensor 63 may include the first and second left rear wheel (RL) wheel speed sensors 63a and 63b in order to implement the redundancy related to an abnormal operating state (e.g., damage, error, reset, power cut off, or the like).

The first and second left rear wheel (RL) wheel speed sensors 63a and 63b may each provide the wheel speed signal WSS3 to the first controller 150 by outputting the wheel speed signal WSS3 through the first channel A and additionally provide the wheel speed signal WSS3 to the second controller 92 through the second channel B in order to implement the redundancy related to the abnormal communication state (e.g., short circuit, error, reset, power cut off, or the like).

The fourth wheel speed sensor 64 may include the first and second right rear wheel (RR) wheel speed sensors 64a and 64b in order to implement the redundancy related to the abnormal operating state (e.g., damage, error, reset, power cut off, or the like).

The first and second right rear wheel (RR) wheel speed sensors 64a and 64b may each provide the wheel speed signal WSS4 to the first controller 150 by outputting the wheel speed signal WSS4 through the first channel A and additionally provide the wheel speed signal WSS4 to the second controller 92 through the second channel B in order to implement the redundancy related to the abnormal communication state (e.g., short circuit, error, reset, power cut off, or the like).

The first controller 150 may control the liquid pressure supply module 200 in response to at least one of the wheel speed signal WSS1 outputted from the first wheel speed sensor 61, the wheel speed signal WSS2 outputted from the second wheel speed sensor 61, the wheel speed signals WSS3 outputted from the first and second left rear wheel (RL) wheel speed sensors 63a and 63b, and the wheel speed signals WSS4 outputted from the first and second right rear wheel (RR) wheel speed sensors 64a and 64b.

When a failure of any one of the first and second left rear wheel (RL) wheel speed sensors 63a and 63b is identified, the first controller 150 may control the liquid pressure supply module 200 in response to the wheel speed signal WSS3 outputted from the remaining one of the first and second left rear wheel (RL) wheel speed sensors 63a and 63b.

In addition, when a failure of any one of the first and second right rear wheel (RR) wheel speed sensors 64a and 64b is identified, the first controller 150 may control the liquid pressure supply module 200 in response to the wheel speed signal WSS4 outputted from the remaining one of the first and second right rear wheel (RR) wheel speed sensors 64a and 64b.

The second controller 92 may control the first and second electronic parking brakes 181 and 182 in response to at least one of the wheel speed signal WSS1 outputted from the first wheel speed sensor 61, the wheel speed signal WSS2 outputted from the second wheel speed sensor 61, the wheel speed signals WSS3 outputted from the first and second left rear wheel (RL) wheel speed sensors 63a and 63b, and the wheel speed signals WSS4 outputted from the first and second right rear wheel (RR) wheel speed sensors 64a and 64b.

When a failure of any one of the first and second left rear wheel (RL) wheel speed sensors 63a and 63b is identified, the second controller 92 may control at least one of the first and second electronic parking brakes 181 and 182 in response to the wheel speed signal WSS3 outputted from the remaining one of the first and second left rear wheel (RL) wheel speed sensors 63a and 63b.

In addition, when a failure of any one of the first and second right rear wheel (RR) wheel speed sensors 64a and 64b is identified, the second controller 92 may control at least one of the first and second electronic parking brakes 81 and 82 in response to the wheel speed signal WSS4 outputted the remaining one of the first and second right rear wheel (RR) wheel speed sensors 64a and 64b.

Even though a failure of any one of the wheel speed sensors 63a, 63b, 64a, and 64b installed in the rear wheels is identified, the second controller 92 may stably perform at least one of the service brake function and the parking brake function of the vehicle 1 by using the wheel speed signals outputted from the remaining wheel speed sensors.

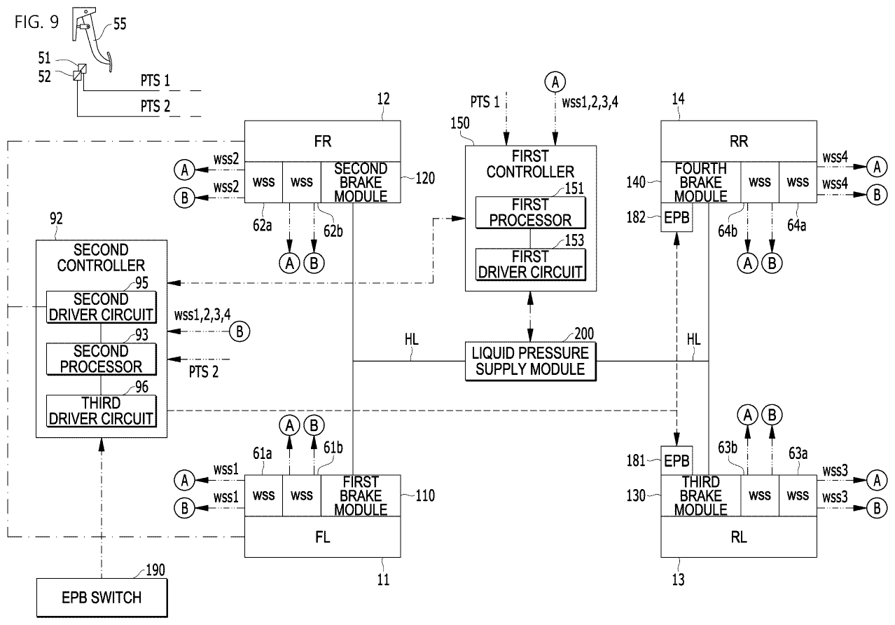

FIG. 9 is a view illustrating a connection relationship between components included in a brake system according to a fourth embodiment of the disclosed disclosure.

In this case, in order to avoid the repeated description, the description will focus on first and second left front wheel (FL) wheel speed sensors 61a and 61b and first and second right front wheel (FR) wheel speed sensors 62a and 62b added to the third embodiment.

With reference to FIG. 9, the first wheel speed sensor 61 may include the first and second left front wheel (FL) wheel speed sensors 61a and 61b in order to implement the redundancy related to an abnormal operating state (e.g., damage, error, reset, power cut off, or the like).

The first and second left front wheel (FL) wheel speed sensors 61a and 61b may each provide the wheel speed signal WSS1 to the first controller 150 by outputting the wheel speed signal WSS1 through the first channel A and additionally provide the wheel speed signal WSS1 to the second controller 92 through the second channel B in order to implement the redundancy related to the abnormal communication state (e.g., short circuit, error, reset, power cut off, or the like).

The second wheel speed sensor 62 may include the first and second right front wheel (FR) wheel speed sensors 62a and 62b in order to implement the redundancy related to the abnormal operating state (e.g., damage, error, reset, power cut off, or the like).

The first and second right front wheel (FR) wheel speed sensors 62a and 62b may each provide the wheel speed signal WSS2 to the first controller 150 by outputting the wheel speed signal WSS2 through the first channel A and additionally provide the wheel speed signal WSS2 to the second controller 92 through the second channel B in order to implement the redundancy related to the abnormal communication state (e.g., short circuit, error, reset, power cut off, or the like).

The first controller 150 may control the liquid pressure supply module 200 in response to at least one of the wheel speed signals WSS1 outputted from the first and second left front wheel (FL) wheel speed sensors 61a and 61b, the wheel speed signals WSS2 outputted from the first and second right front wheel (FR) wheel speed sensors 62a and 62b, the wheel speed signals WSS3 outputted from the first and second left rear wheel (RL) wheel speed sensors 63a and 63b, and the wheel speed signals WSS4 outputted from the first and second right rear wheel (RR) wheel speed sensors 64a and 64b.

When a failure of any one of the first and second left front wheel (FL) wheel speed sensors 61a and 61b is identified, the first controller 150 may control the liquid pressure supply module 200 in response to the wheel speed signal WSS1 outputted from the remaining one of the first and second left front wheel (FL) wheel speed sensors 61a and 61b.

When a failure of any one of the first and second right front wheel (FR) wheel speed sensors 62a and 62b is identified, the first controller 150 may control the liquid pressure supply module 200 in response to the wheel speed signal WSS2 outputted from the remaining one of the first and second right front wheel (FR) wheel speed sensors 62a and 62b.

When a failure of any one of the first and second left rear wheel (RL) wheel speed sensors 63a and 63b is identified, the first controller 150 may control the liquid pressure supply module 200 in response to the wheel speed signal WSS3 outputted from the remaining one of the first and second left rear wheel (RL) wheel speed sensors 63a and 63b.

In addition, when a failure of any one of the first and second right rear wheel (RR) wheel speed sensors 64a and 64b is identified, the first controller 150 may control the liquid pressure supply module 200 in response to the wheel speed signal WSS4 outputted from the remaining one of the first and second right rear wheel (RR) wheel speed sensors 64a and 64b.

The second controller 92 may control the first and second electronic parking brakes 181 and 182 in response to at least one of the wheel speed signals WSS1 outputted from the first and second left front wheel (FL) wheel speed sensors 61a and 61b, the wheel speed signals WSS2 outputted from the first and second right front wheel (FR) wheel speed sensors 62a and 62b, the wheel speed signals WSS3 outputted from the first and second left rear wheel (RL) wheel speed sensors 63a and 63b, and the wheel speed signals WSS4 outputted from the first and second right rear wheel (RR) wheel speed sensors 64a and 64b.

When a failure of any one of the first and second left front wheel (FL) wheel speed sensors 61a and 61b is identified, the second controller 92 may control at least one of the first and second electronic parking brakes 181 and 182 in response to the wheel speed signal WSS1 outputted from the remaining one of the first and second left front wheel (FL) wheel speed sensors 61a and 61b.

When a failure of any one of the first and second right front wheel (FR) wheel speed sensors 62a and 62b is identified, the second controller 92 may control at least one of the first and second electronic parking brakes 181 and 182 in response to the wheel speed signal WSS2 outputted from the remaining one of the first and second right front wheel (FR) wheel speed sensors 62a and 62b.

When a failure of any one of the first and second left rear wheel (RL) wheel speed sensors 63a and 63b is identified, the second controller 92 may control at least one of the first and second electronic parking brakes 181 and 182 in response to the wheel speed signal WSS3 outputted from the remaining one of the first and second left rear wheel (RL) wheel speed sensors 63a and 63b.

In addition, when a failure of any one of the first and second right rear wheel (RR) wheel speed sensors 64a and 64b is identified, the second controller 92 may control at least one of the first and second electronic parking brakes 181 and 182 in response to the wheel speed signal WSS4 outputted the remaining one of the first and second right rear wheel (RR) wheel speed sensors 64a and 64b.

Even though a failure of any one of the wheel speed sensors 63a, 63b, 64a, and 64b installed in the rear wheels is identified, the second controller 92 may stably perform at least one of the service brake function and the parking brake function of the brake system 100 by using the wheel speed signals outputted from the remaining wheel speed sensors.

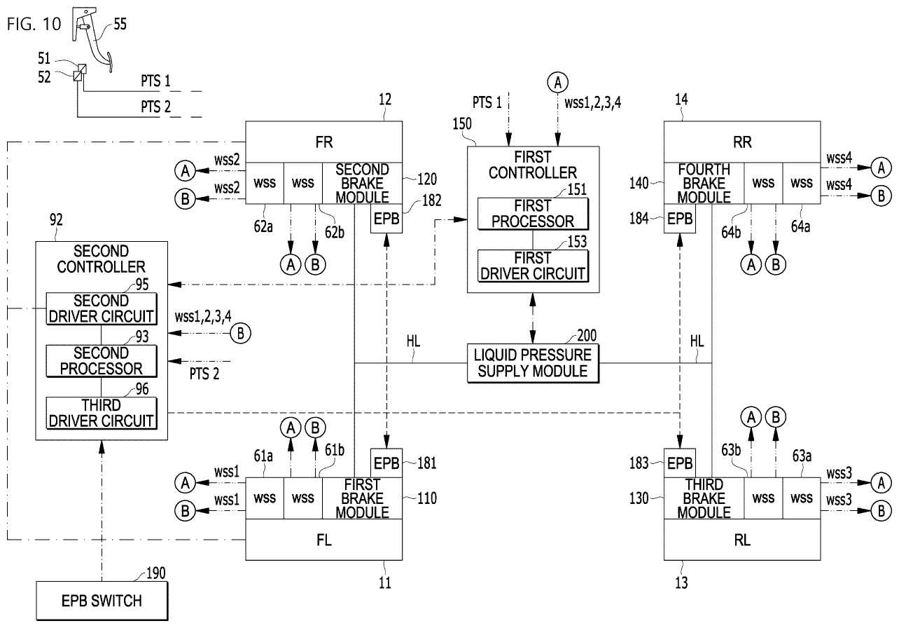

FIG. 10 is a view illustrating a connection relationship between components included in a brake system according to a fifth embodiment of the disclosed disclosure.

In this case, in order to avoid the repeated description, the description will focus on the first to fourth electronic parking brakes 181, 182, 183, and 184 added to the fourth embodiment.

With reference to FIG. 10, the brake system 100 may include the first to fourth electronic parking brakes 181, 182, 183, and 184 respectively installed in the plurality of wheels 11, 12, 13, and 14.

The second controller 92 may identify an operating state (e.g., a normal state or a failure state) of the first controller 150 on the basis of whether the first controller 150 receives a periodic status signal.

When a failure of the first controller 150 is identified, the second controller 92 may output the braking control signals for controlling the operations of the first and second electronic parking brakes 181 and 182 to the first and second electronic parking brakes 181 and 182 through the third internal communication network CAN3 and output the braking control signals for controlling the operations of the third and fourth electronic parking brakes 81 and 82 through the fourth internal communication network CAN4 to the first and second electronic parking brakes 181 and 182.

The second controller 92 may identify the operating state (e.g., the normal state or the failure state) of the first controller 150 on the basis of whether the first controller 150 receives the periodic status signal.

When a failure of the first controller 150 is identified, the second controller 92 may output the braking control signals for controlling the operations of the first and second electronic parking brakes 181 and 182 to the first and second electronic parking brakes 181 and 182 through the third internal communication network CAN3 and output the braking control signals for controlling the operations of the third and fourth electronic parking brakes 81 and 82 through the fourth internal communication network CAN4 to the first and second electronic parking brakes 181 and 182.

Even though the failure of the first controller 150 is identified, the second controller 92 may stably perform at least one of the service brake function and the parking brake function of the brake system 100 by using the first to fourth electronic parking brakes 181, 182, 183, and 184.

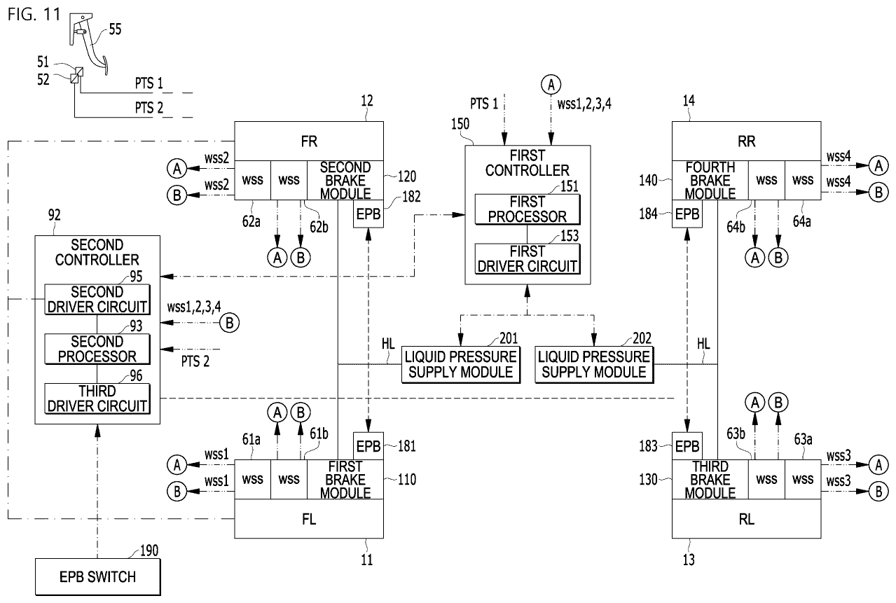

FIG. 11 is a view illustrating a connection relationship between components included in a brake system according to a sixth embodiment of the disclosed disclosure.

In this case, in order to avoid the repeated description, the description will focus on first and second liquid pressure supply modules 201 and 202 added to the fifth embodiment.

With reference to FIG. 11, the first controller 150 may be connected to the first liquid pressure supply module 201 and the second liquid pressure supply module 202, control the first liquid pressure supply module 201 to supply the liquid pressure to the first and second brake modules 110 and 120 related to braking of the front wheels 11 and 12, and control the second liquid pressure supply module 201 to supply the liquid pressure to the third and fourth brake modules 130 and 140 related to braking of the rear wheels 13 and 14.

In this case, even if any one of the first liquid pressure supply module 201 and the second liquid pressure supply module 202 is abnormal, the brake system 100 may perform the braking control on the wheels 11, 12, 13, and 14 of the vehicle 1 without a failure.

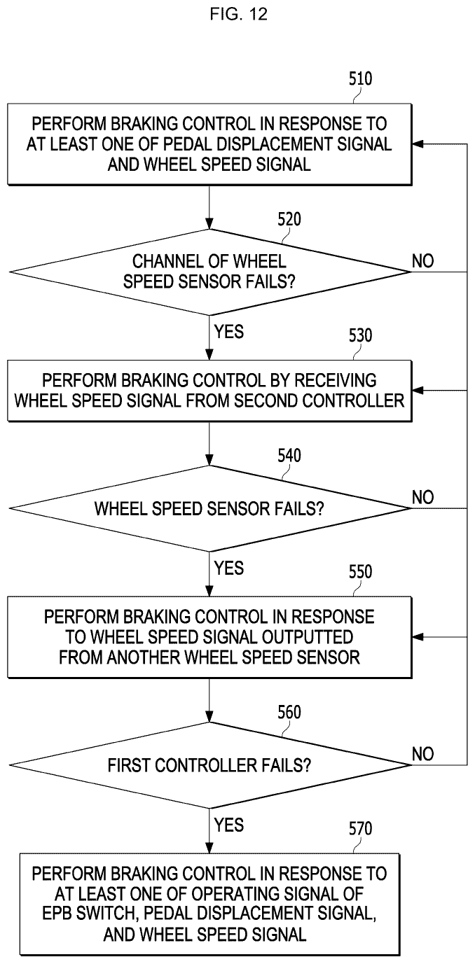

FIG. 12 is a view illustrating a method of controlling the brake system according to the embodiment of the disclosed disclosure.

Hereinafter, a method of controlling the brake system according to the first embodiment of the disclosed disclosure will be described.

With reference to FIG. 12, according to the method of controlling the brake system according to the embodiment of the disclosed disclosure, the first controller 150 may perform the braking control on the first to fourth brake modules 110, 120, 130, and 140 in response to at least one of the pedal displacement signal PTS1 outputted from the pedal displacement sensor 50 and the first to fourth wheel speed signals WSS1, WSS2, WSS3, and WSS4 outputted from the first to fourth wheel speed sensors 61, 62, 63, and 64 respectively installed in the first to fourth wheels 11, 12, 13, and 14 (510).

In this case, the first controller 150 may control the liquid pressure generation motor 236 of the liquid pressure supply module 200 configured to supply the liquid pressure to the first to fourth brake modules 110, 120, 130, and 140.

The first to fourth wheel speed sensors 61, 62, 63, and 64 may output the wheel speed signals to the first controller 150 through the first channels A and output the wheel speed signals to the second controller 92 of the steering system 80 through the second channels B.

When a failure of the first channel A is identified as the first controller 150 cannot receive at least one of the first to fourth wheel speed signals WSS1, WSS2, WSS3, and WSS4 from the first to fourth wheel speed sensors 61, 62, 63, and 64 (520), the first controller 150 may perform the braking control on the first to fourth brake modules 110, 120, 130, and 140 by receiving the wheel speed signal from the second controller 92 on the basis of the result of identifying the failure of the first channel A (530).

In addition, when a failure of the wheel speed sensor is identified as the first controller 150 cannot receive at least one of the first to fourth wheel speed signals WSS1, WSS2, WSS3, and WSS4 from the first to fourth wheel speed sensors 61, 62, 63, and 64 (540), the first controller 150 may perform the braking control on the first to fourth brake modules 110, 120, 130, and 140 in response to the wheel speed signal outputted from the remaining wheel speed sensors (550).

When a failure of the first controller 150 is identified as the second controller 92 cannot communicate with the first controller 150 (560), the second controller 92 may perform the braking control on the first and second electronic parking brakes 181 and 182 in response to at least one of the operating signal of the EPB switch 190, the pedal displacement signal PTS2, and the first to fourth wheel speed signals WSS1, WSS2, WSS3, and WSS4 outputted from the first to fourth wheel speed sensors 61, 62, 63, and 64 respectively installed in the first to fourth wheels 11, 12, 13, and 14 (570).

In addition, the second controller 92 may control the steering motor 88 configured to provide the driving power in the steering system 80.

In this case, the second controller 92 may perform the braking control on at least one of the electronic parking brakes, which are installed in the rear wheels of the vehicle, and the electronic parking brakes installed in the front and rear wheels of the vehicle.

On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Specific examples thereof may include a read only memory (ROM), a random access memory (RAM), a magnetic tape, a magnetic disc, a flash memory, an optical data storage device, and the like.

The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. For example, a “non-transitory storage medium” may include a buffer that temporarily stores data.

While the disclosed embodiments have been described above with reference to the accompanying drawings, the embodiments are just illustrative and not intended to limit the present specification. It can be appreciated that various modifications and alterations, which are not described above, may be made to the present embodiment by those skilled in the art to which the present specification pertains without departing from the intrinsic features of the present disclosure. The respective constituent elements specifically described in the embodiments may be modified and then carried out. Further, it should be interpreted that the differences related to the modifications and applications are included in the scope of the present specification defined by the appended claims.

What is claimed is:

1. A brake system comprising:
a plurality of wheel speed sensors respectively installed in a plurality of wheels of a vehicle;
a plurality of hydraulic brake modules related to braking of the plurality of wheels; and
a first controller configured to perform braking control on the plurality of hydraulic brake modules in response to at least one of a pedal displacement signal, which corresponds to a movement of a brake pedal, and wheel speed signals outputted from the wheel speed sensors,
wherein when a failure of the first controller is identified, a second controller, which is provided in a steering system of the vehicle, performs braking control on an electronic parking brake, which is provided in at least one of the plurality of wheels, in response to at least one of an operating signal of an EPB switch, the pedal displacement signal, and the wheel speed signals outputted from the wheel speed sensors.

2. The brake system of claim 1, further comprising:
a liquid pressure supply module configured to supply liquid pressure to the plurality of hydraulic brake modules by being operated by a first motor,
wherein the first controller comprises:
a first processor configured to perform braking control on at least one of the plurality of hydraulic brake modules; and
a first driver circuit configured to control the first motor to allow the liquid pressure supply module to supply the liquid pressure to at least one of the plurality of hydraulic brake modules in response to a control signal outputted from the first processor.

3. The brake system of claim 1, wherein the electronic parking brake performs at least one of a service brake function, which provides a braking force in a traveling situation of the vehicle, and a parking brake function that maintains a stopped state of the vehicle.

4. The brake system of claim 2, wherein the second controller of the steering system comprises:
a second processor configured to control at least one of the steering system and the electronic parking brake;
a second driver circuit configured to control a second motor, which provides driving power in the steering system, in response to a control signal outputted from the second processor; and
a third driver circuit configured to control a third motor, which provides driving power in the electronic parking brake, in response to the control signal outputted from the second processor.

5. The brake system of claim 1, wherein the plurality of wheel speed sensors each output the wheel speed signal through a first channel and a second channel, output the wheel speed signal to the first controller through the first channel, and output the wheel speed signal to the second controller through the second channel.

6. The brake system of claim 5, wherein the second controller of the steering system performs braking control on the electronic parking brake by receiving the wheel speed signal from the first controller on the basis of a result of identifying a failure of the second channel.

7. The brake system of claim 1, wherein when a failure of the wheel speed sensor installed in at least one of the plurality of wheels is identified, the first controller performs braking control on the hydraulic brake module in response to the wheel speed signal outputted from the wheel speed sensor installed in the remaining wheel.

8. The brake system of claim 1, further comprising:
an internal communication network configured to connect the first controller and the second controller of the steering system,
wherein the first controller and the second controller of the steering system identify states thereof through the internal communication network.

9. The brake system of claim 1, wherein the plurality of wheel speed sensors comprise a first wheel speed sensor and a second wheel speed sensor installed in a first wheel of the vehicle.

10. The brake system of claim 1, wherein the plurality of wheel speed sensors comprise first and second wheel speed sensors respectively installed in first and second wheels of the vehicle.

11. The brake system of claim 1, wherein the second controller of the steering system performs braking control on the electronic parking brake installed in a second wheel of the vehicle.

12. The brake system of claim 1, wherein the second controller of the steering system performs braking control on the electronic parking brakes respectively installed in first and second wheels of the vehicle.

13. The brake system of claim 1, further comprising:
first and second hydraulic pressure supply modules configured to supply hydraulic pressure to the hydraulic brake module,
wherein the first controller controls the first and second hydraulic pressure supply modules to supply the hydraulic pressure to the hydraulic brake module.

14. A method of controlling a brake system, which comprises a plurality of wheel speed sensors respectively installed in a plurality of wheels of a vehicle, a plurality of hydraulic brake modules related to braking of the plurality of wheels, and a first controller configured to perform braking control on the plurality of hydraulic brake modules, the method comprising:
performing, by the first controller, braking control on the plurality of hydraulic brake modules in response to at least one of a pedal displacement signal, which corresponds to a movement of a brake pedal, and wheel speed signals outputted from the wheel speed sensors; and
performing, by a second controller provided in a steering system of the vehicle, braking control on an electronic parking brake, which is provided in at least one of the plurality of wheels, in response to at least one of an operating signal of an EPB switch, the pedal displacement signal, and the wheel speed signals outputted from the wheel speed sensor when a failure of the first controller is identified.

15. The method of claim 14, further comprising:
controlling, by the first controller, a first motor of a liquid pressure supply module configured to supply liquid pressure to the plurality of hydraulic brake modules.

16. The method of claim 14, further comprising:
controlling a second motor, which provides driving power in the steering system, by the second controller of the steering system; and
controlling a third motor configured to provide driving power to the electronic parking brake.

17. The method of claim 14, further comprising:
outputting, by the plurality of wheel speed sensors, the wheel speed signals through first and second channels,
wherein the wheel speed signal is outputted to the first controller through the first channel, and the wheel speed signal is outputted to the second controller of the steering system through the second channel.

18. The method of claim 17, further comprising:
performing, by the second controller of the steering system, braking control on the electronic parking brake by receiving the wheel speed signal from the first controller on the basis of a result of identifying a failure of the second channel.

19. The method of claim 14, further comprising:
performing, by the first controller, braking control on the hydraulic brake module in response to the wheel speed signal outputted from the wheel speed sensor installed in the remaining wheel when a failure of the wheel speed sensor installed in at least one of the plurality of wheels is identified.

20. The method of claim 14, further comprising:
performing, by the second controller of the steering system, braking control on the electronic parking brake installed in a second wheel of the vehicle; and
performing braking control on the electronic parking brakes respectively installed in a first wheel and the second wheel of the vehicle.
